(19) United States
(12) Patent Application Publication
(10) Pub. No.: US 2015/0124438 A1
(43) Pub. Date: May 7, 2015

(54) Tactical Flashlight Tail Cap

(71) Applicant: Richard Jeff Garcia, Beaumont, CA (US)

(72) Inventor: Richard Jeff Garcia, Beaumont, CA (US)

(73) Assignee: JANLINCIA LLC, Yucaipa, CA (US)

(21) Appl. No.: 14/070,516

(22) Filed: Nov. 2, 2013

(51) Int. Cl. F21L 4/00

(52) U.S. Cl. CPC F21L 4/00
USPC 362/208

(57) ABSTRACT

A flashlight tail cap that operates both as a tactical tail cap as well as allowing tail standing.

### CROSS-REFERENCE TO RELATED APPLICATIONS

This application claims the benefit of provisional patent application 61/722,148 filed Nov. 3, 2012.

### BACKGROUND—PRIOR ART

As white LED lights become more common new and more specialized uses are found for them. One specialized use is for tactical flashlights. Tactical flashlights are used in situations where life or property may be at risk, for example from criminals. Frequently they are used in close quarters indoors, such as inside a house or building. First responders such as police officers must operate without knowing in advance who or what occupies the building. If the lighting is poor or non-existent then a flashlight is typically used to provide light. The purpose of tactical flashlights is to use light for two purposes. First to identify who or what the light is illuminating. Before a decision can be made regarding what response is appropriate an identification must be made. This is especially true where civilians or innocent bystanders may be present. If the light reveals a child is down a hallway then the response will be very different than if the light reveals that a person carrying a weapon is down the same hallway. The second purpose of the tactical light is to reduce a suspects ability to cause harm by momentarily blinding them with bright light.

One feature that is common on tactical lights is to have the flashlight on/off switch located on the flashlight tail cap and be operated by a thumb or palm. The tail cap is the end of the flashlight that is opposite from the light emitting end. The light emitting end of the flashlight is referred to as the head of the flashlight. The button is located on the tail cap inline with the flashlight body so that so matter how the light is oriented or held, the switch is in a known location. This is unlike older flashlights that had a button or slide switch on the side of the light and closer to the head, or light emitting end, of the flashlight. For many military and law enforcement personnel the preference is to have the switch extend out past the flashlight housing so that it can be pressed by the palm of a hand. The reason why this feature is preferred is that certain pistol grip and flashlight techniques, such as the Hargreaves Lite-Touch technique or the Rogers Technique, work best with the button sticking out past the flashlight housing. This arrangement of the switch protruding out past the flashlight body works well for purely tactical situations, however there are other times when it is a problem to have the on/off switch sticking out. For example the switch sticking out makes it more likely to be accidentally pressed. The switch sticking out also makes placing the flashlight on a flat surface and having it face directly up, commonly called tail standing, impractical. Tail standing is useful when using the light to illuminate a room when you need both hands free. Since the switch is fairly small, and often rounded, tail standing is not possible with existing tactical flashlights that have the switch protruding past the flashlight housing.

My invention improves existing tactical flashlights by employing a sliding sleeve that allows the flashlight to operate either in the tail stand position or with the button protruding for tactical pistol grips. I call this invention a tactical tail stand. The invention is comprised of a sleeve on the back, or tail end, of the flashlight that can slide such that it allows the switch to either be protruding past the sliding sleeve in one position or to have the sliding sleeve extend past the switch, thus allowing tail standing, in a second position. The sleeve is designed so that it has enough resistance to motion that it won't slip under the weight of the flashlight when tail standing, but is still easily pushed in with a single hand for tactical situations. Due to the seriousness of tactical situations it is paramount that the tail stand be easily retracted, ideally without requiring any fine motor skills since in high stress situations fine motor skills decline.

### SUMMARY

In summary there are several considerations to this invention in order to maximize the utility. The first is that since tactical situations may be encountered with little warning, the tail stand must be easily pushed in using a single hand. Typically this would be done with the palm or thumb. This is best accomplished in a single pushing motion, without twisting required to save time and better allow a single hand to accomplish the task. Second, the sleeve needs to have a means to keep it from freely sliding since in the extended position while tail standing the full weight of the flashlight will be trying to push the sleeve back. Should the sleeve be pushed back in, then the switch will be exposed causing the flashlight to not be flush with the surface that it would be resting on. In short the flashlight will tip over if the sleeve does not extend past the switch. The third consideration is that a space must be present to allow the user to attach a lanyard. Lanyards are often used with flashlights since they prevent the light from accidentally being dropped. Since the sleeve has a range of motion, space must exist along that entire range of motion for the lanyard.

### ADVANTAGES OVER PRIOR ART

The prior art doesn't have any flashlight tailcaps with a moving part that allows both having the on/off button sticking out for tactical needs and then having a flat surface for tailstanding. There are flashlights that are designed as tactical models with the button exposed, such as the Surefire 6PX, or designed to allow tail standing, such as the 4Sevens Quark. There are people who have made separate adapters that attach to tactical flashlights to allow them to tail stand. However there isn't an instance of a moving part allowing a tailcap to meet both of these needs.

### SUMMARY OF ADVANTAGES OVER PRIOR ART

(A) User can enjoy the functionality of a tail standing flashlight
(B) User can enjoy the functionality of a tactical flashlight
(C) User can rapidly rapidly convert from a tail stand configuration to a tactical configuration using only a single push and only requiring one hand

### DRAWINGS—FIGURES

FIG. 1 shows an embodiment of a flashlight sleeve from a sectional view

### DRAWINGS-REFERENCE NUMERALS

10—Sliding sleeve
20—Inside lip on sleeve 10 that slides along tail cap cutout 80
30—Pair of holes in sliding sleeve 10 to allow for lanyard loop
40—O-ring to seal switch boot
50—Electronic switch assembly including push button switch
60—O-rings to provide friction and smooth motion
70—Battery tube of flashlight
80—Cutout on tail cap 100 to allow sleeve lip to slide along
90—Inner lip on tail cap to allow electronic controls 50 to rest against
100—Flashlight tail cap that screws into battery tube 70

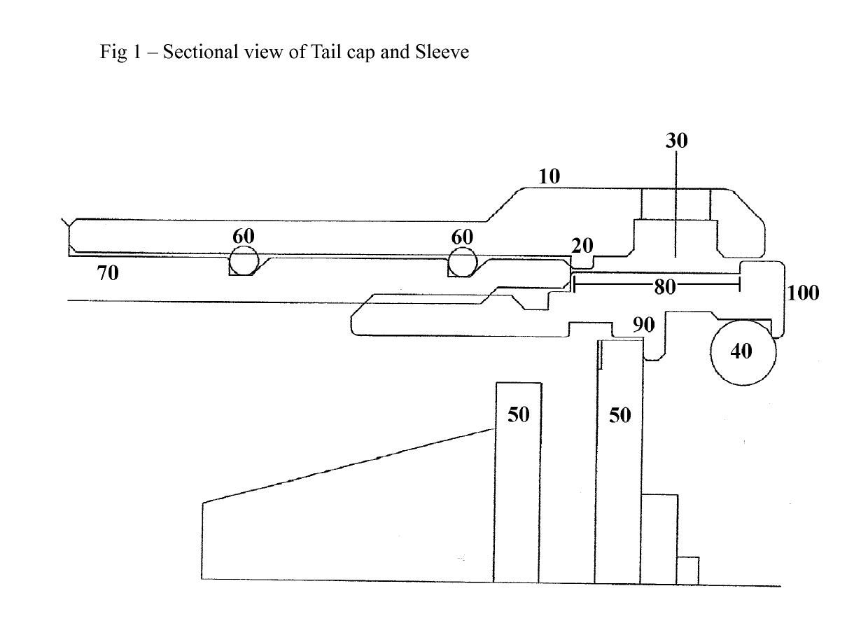

### DETAILED DESCRIPTION—FIG. 1

The drawing in FIG. 1 shows both the sleeve and the tail cap from a sectional view from the center axis of the part to the top. The part is symmetric about the center axis, so the bottom half that isn't shown would be identical to the upper half that is shown.

Sleeve 10 is retained between flashlight battery tube 70 and tail cap 100. Tail cap 100 screws into battery tube 70, allowing for easy installation of sleeve 10. Sleeve 10 has inner lip 20 that is able to slide along cutout 80 on tail cap 100. Tail cap 100 also has inner lip 90 that is used to retain electronic switch assembly 50. Inner lip 90 is not anodized or otherwise electrically isolated, so it also provides an electrical connection to the flashlight body for electronic switch assembly 50. Holes 30 are a small pair of holes that allows for a lanyard to be used by looping it through the two holes. There is a undercut that goes all the way around the flashlight so that the lanyard loop won't interfere with sleeve 10′s sliding motion. O-ring 40 seals against tail cap 100 and a boot to cover the button that is part of electronics assembly 50. This allows electronics assembly 50 to be water resistant or water proof as desired. O-rings 60 provide a slight interference with sleeve 10 to keep sleeve 10 from sliding too freely.

### OPERATION—FIRST EMBODIMENT

The main purpose of this invention is to have a sliding sleeve that has enough resistance to motion that it won't slip to the inside, that is retracted, position under the weight of the flashlight when tail standing, yet not have so much resistance to motion that it can't be pushed in, or retracted, with just one hand. This design goal is achieves through the use of o-rings 60 to provide friction against the sleeve 10. O-rings 60 also help stabilize the sleeve so that it slides smoothly and evenly, with no rocking or otherwise having the sleeve not be parallel to the flashlight center axis.

### OPERATION—ALTERNATE EMBODIMENTS

There are some variations on this method that allow for different implementations. These include:

Have additional features at the top and bottom of cutout 80 so that the sleeve can be locked in either of the two positions with a twist. This may be preferred by some users who value having the tail cap being locked into a known position more than they value being able to quickly convert to a tactical configuration. These additional features may be a channel on the tail cap that guides a small post on the sliding sleeve or other methods known to one skilled in the art.

The basic design indicated in the drawing allows including features so that the operation changes depending on the position of sleeve 10. For example when sleeve 10 is positioned such that the button extends out then the flashlights acts in the momentary on mode. When sleeve 10 is in the tail stand position then the flashlight operates in a multi-mode manner. This is convenient for the user and consistent with what the user likely wants based on the position of sleeve 10. The position of sleeve 10 could be detected by using a small magnetic ring attached to sleeve 10 and a hall effect sensor in electronics assembly 50, using a simple push button or limit switch to detect the position of sleeve 10, using a light sensor to look for a hole or a specific reflection, or in any manner of other ways known to those skilled in the art. These methods of detecting the sleeve position would typically be integrated into electronic assembly 50 and one of the mechanical parts.

Since sleeve 10 is free to be twisted, it can have a magnet, accelerometer or gyro, or some other way to detect twisting and then be used as both a switch as well as a means to change the flashlight's mode or light intensity. This functionality could be added to electronics switch assembly 50.

Instead of using a sliding sleeve a twisting or screwing motion could be used instead to move sleeve 10 between positions. This is be easily accomplished by using a threaded interface instead of smooth cutout 80. This approach would also likely mean that o-rings 60 could be reduced or eliminated since the threads would help keep sliding sleeve 10 level.

Additional positions can be added that allow for variations in how far the on/off switch extends past sleeve 10. For example instead of two positions a third position could be added where the on/off switch is only slightly exposed.

I claim:

1. A flashlight where the non-light emitting end has a mechanism that allows a button to extend past the mechanism in one position and where the mechanism extends past the button in a second position.

2. The mechanism of claim 1 where said mechanism allows a lanyard to be mounted without interfering with said mechanism as it moves from one position to another position.

3. A flashlight where the end facing away from the main light has a button or switch and a moving part that has at least two positions, where one position of said moving part allows said button or switch to extend past said moving part and a second position where said button or switch does not extend past said moving part.

4. The moving part of claim 3 where said moving part allows a lanyard to be mounted without interfering with said moving part as it moves from one position to another position.

5. The mechanism of claim 1 where said mechanism can be operated with a single push to said mechanism to move said mechanism from at one position to another position.

6. The mechanism of claim 1 where said mechanism can be operated with a single hand to move said mechanism from one position to another position.

7. The moving part of claim 3 where said moving part can be operated with a single push to said moving part to move said moving part from one position to another position.

8. The moving part of claim 3 where said moving part can be operated with a single hand to move said moving part from one position to another position.

9. The moving part of claim 3 where the moving part is an assembly composed of one or more components.

10. The mechanism of claim 1 where said mechanism can be operated with a twisting motion to said mechanism to move said mechanism from one position to another position.

11. The moving part of claim 3 where said moving part can be operated with a twisting motion to said moving part to move said moving part from one position to another position.

12. The mechanism of claim 1 where said mechanism allows the flashlight to operate in one mode in a first position and a different mode in a different position.

13. The moving part of claim 3 where said moving part allows the flashlight to operate in one mode in a first position and a different mode in a different position.

14. The mechanism of claim 1 where said mechanism allows a loop to be attached without interfering with the mechanism moving between positions.

15. The moving part of claim 3 where said moving part allows a loop to be attached without interfering with said moving part changing from a first position to a different position.

16. A flashlight that has at least one button used to control the flashlight where said button can be exposed or at least partially covered by a sleeve.

17. The flashlight of claim 16 where the sleeve allows said flashlight to stand with the light facing up in at least one position of said sleeve.

18. The sleeve of claim 16 where said sleeve allows a lanyard to be mounted without interfering with said sleeve as it moves from one position to another position.

19. The sleeve of claim 16 where said sleeve can be operated with a single push to move said sleeve from one position to another position.

20. The sleeve of claim 16 where said sleeve can be moved with a single hand from one position to another position.

21. The sleeve of claim 16 where said sleeve is an assembly composed of one or more components.

22. The sleeve of claim 16 where said sleeve can be operated with a twisting motion to move said sleeve from one position to another position.

23. The flashlight with a sleeve of claim 16 where said sleeve allows said flashlight to operate in one mode in a first position and a different mode in a different position.

24. The sleeve of claim 16 where said sleeve allows a loop to be attached without interfering with said sleeve changing from a first position to a different position.
